(19) United States
(12) Patent Application Publication
(10) Pub. No.: US 2022/0205803 A1
(43) Pub. Date: Jun. 30, 2022

(54) INTELLIGENT OBJECT TRACING SYSTEM UTILIZING 3D MAP RECONSTRUCTION FOR VIRTUAL ASSISTANCE

(71) Applicant: Samsung Electronics Co., Ltd., Suwon-si (KR)

(72) Inventors: Wisma Chaerul KARUNIANTO, Jakarta (ID); Dinan FAKHRI, Jakarta (ID); Shah Dehan LAZUARDI, Jakarta (ID); Andreas KOSASIH, Jakarta (ID); Christyan Tamaro NADEAK, Jakarta (ID); Dickson WIDJAJA, Jakarta (ID)

(21) Appl. No.: 17/561,348

(22) Filed: Dec. 23, 2021

(30) Foreign Application Priority Data
Dec. 28, 2020 (ID) P00202010666
Apr. 27, 2021 (KR) 10-2021-0054230

(51) Int. Cl. G01C 21/36; G01C 21/30; G01C 21/00; G06V 10/75

(52) U.S. Cl. CPC G01C 21/3638; G01C 21/30; G01C 21/365; G06V 10/751; G01C 21/3837; G01C 21/3811; G01C 21/367

(57) ABSTRACT

Disclosed is a system and method of an advanced intelligent object tracing system utilizing 3D map reconstruction to provide virtual assistance utilizing only camera system and sensors as the main data input. The present disclosure may use a deep learning algorithm and a neural network to perform 3D map generation, distance calculation, object detection and recognition, and utilize augmented reality to display virtual directions.

### CROSS-REFERENCE TO RELATED APPLICATIONS

This application is based on and claims priorities under 35 U.S.C. 119 to Indonesian Patent Application No. P00202010666 filed on Dec. 28, 2020, in the Indonesian Intellectual Property Office, and Korean Patent Application No. 10-2021-0054230 filed on Apr. 27, 2021, the disclosures of which are herein incorporated by reference in their entirety.

### BACKGROUND

### 1. Field

The present disclosure relates generally as a system and method to present virtual assistance using intelligent object tracing system to generate a 3D map by tracing objects in spatial environment. The system and method proposed according to the present disclosure has the advantage that it only employs computing power, image processing and sensors as its primary hardware requirements, and it does not require the use of Global Positioning System (GPS) to perform location tracing.

### 2. Description of Related Art

The development of 3D map reconstruction has been rapidly progressing these days. The 3D map reconstruction system can be utilized for object recognition and tracing by using camera to take images and videos of real world surrounding to be processed with computational methods. Additionally, the advancement of Augmented Reality (AR) technology has enabled its application to improve User Experience (UX) in providing directional information within route guiding platforms, such as a 3D map.

The performance of AR technology can be enriched through collaboration with Deep Learning (DL) algorithms or electronic products. For example, AR technology can be used to provide virtual assistance for users. Virtual assistance could provide virtual direction, position, and distance estimation in ‘open space’ and in real-time conditions. Associating 3D map reconstruction with AR can provide an improved object tracing system. For example, it can extract information from image/video and use the extracted information to perform 3D map reconstruction. For example, it can also process the extracted information from image/video to intelligently recognize then trace an object and further generate virtual direction, position, and distance estimation for the respected object.

A system to provide virtual assistance for users can be assembled by combining 3D map reconstruction and AR. The system can support the vast availability of moving/stationary devices with image sensors that make it easier to gather the data needed, wherein many earlier implementations can use GPS signal alongside with cell phone signal, gyroscope, accelerometer and many other sensors to make it work.

In the past, a vast amount of computing power is usually required to process complex activity such as detecting object, reconstructing 3D map, and generating augmented virtual assistance. However, the state of the art mobile devices are embedded with built-in Neural Processing Unit (NPU) that will enable Artificial Intelligence (AI) processing and executing DL tasks directly on the device. With on-device AI, executing a task, such as object recognition, can be done using a pre-trained model.

There are some patent publications having relevance to the present disclosure.

A reference, KR20180094493 A, discloses a method for generating an indoor map. This method relates to a unidirectional transmission system between two devices connected to a network, wherein a transmitter device includes an IP address of each terminal in a second network and a MAC address corresponding to each IP address.

Another reference, KR20160079512, discloses a method of estimating a vehicle location in an indoor parking lot, using an image sensor for acquiring image data, installed in a vehicle, and a controller processor for detecting its characteristic information.

Still another reference, KR1809537 B1, discloses a route guidance method using a photo or video image.

Still another reference, US20200053292 A1, discloses an object tracking method, of which tracking system is designed for the environment where Global Positioning System (GPS), radio frequency (RF) and/or cellular communication signals are not available.

### SUMMARY

The present disclosure provides a system and method to present augmented virtual assistance for object tracing in spatial environment using 3D reconstructed map.

It is an object of the present disclosure to eliminate dependency to GPS signal and utilize data from sensors with high quality of image processing and DL algorithm.

The present disclosure can provide virtual assistance (or guidance) to utilize images/videos and sensor data contributed by multiple users, at a minimum of two (2) electronic devices (or participating devices) with image/video processing system and sensors to perform, for example, mapping of surrounding environment (indoor/outdoor), image processing, tracing and detecting objects, and image/sound/haptic feedback.

The present disclosure may require a device with minimum requirements of high resolution panoramic image or video, magnetometer, gyroscope and accelerometer sensors, processing software with high quality of image processing algorithm. Most of the state of the art devices and cameras today have also been embedded with computing power using on device AI technology which makes it possible for the system to run the algorithm directly on the device. A fast connectivity and large network bandwidth are desirable to ensure fast transfer of data between devices.

There are already several patents and public papers that explore various methods for object detection, map reconstruction, route guiding and so on. However, none of the disclosures discussed methods on how to leverage of those topics into an intelligent system that automatically reconstruct 3D map and perform virtual assistance using AR.

According to the present disclosure, there is provided an integrated intelligent system that utilizes a deep learning method to generate virtual assistance in the form of an AR direction using a 3D map that is configured using images and data from sensors.

Meanwhile, an object of the present disclosure is to track an object in the surrounding environment to present augmented virtual assistance and generate a 3D map. The present disclosure may be used in both indoor and outdoor environments.

Further, the present disclosure may generate a 3D map using stored image data and sensor data from a plurality of devices and provide virtual assistance in the form of an AR direction.

In addition, the present disclosure may use only sensor data and images collected from a paired device as a data bundle. The sensor data may be collected from magnetometers, accelerometers and gyroscopes. The filtered data bundle may be used to create a 3D map and update an agent's location in the map.

Furthermore, the system according to the present disclosure may be configured to perform visual and/or conventional driving distance measurements using images captured with a camera in the surrounding environment in conjunction with inertial measurements. It is an object of the present disclosure to process 3D map reproduction, detect an object and create augmented virtual assistance, using an embedded NPU that enables AI processing and DL operations.

Most of the foregoing references above only focus on providing some part of our disclosure. On the other hand, the present disclosure may provide a novel method to process images and sensor data to perform object tracing and reconstruct 3D map to search for similarities from multiple data streams that can be processed to provide AR virtual assistance to users.

The present disclosure proposes a new scheme of an intelligent object tracing system to provide augmented virtual assistance by detecting objects to reconstruct 3D map and trace location in spatial environment. The present disclosure proposes a novel method on how to utilize high quality of image processing and algorithm to perform the 3D map reconstruction to provide augmented virtual assistance as the end result. The present disclosure may generate a 3D map using images or videos, and sensor data from magnetometer, accelerometer and gyroscope that can be processed using a pre-defined DL model.

The system of the present disclosure may use a Convolutional Neural Network (CNN) to generate 3D map and trace location. The CNN model may analyze the ego-motion from whole images and compute transformation vectors for objects to estimate the depth map that can be used to construct a 3D map. The 3D map may provide visual cue for directions when the system recognizes the same objects that are captured on different data stream.

With the 3D map, the CNN model may then create contours and map the detected objects in 3D form by inserting several images, based on its relative position. The CNN model may estimate the distance of every object in the processed images, and identify and list the objects that can be labeled. This list of objects may be used as the base for comparison to determine the similarity level between detected objects and references from other data stream. When user scans an object, the system may detect and compare the object with listed objects to determine the similarity level. A high similarity level may mean the surrounding environment has been scanned previously by other devices, and the system may calculate and show the direction to reach the nearest agent location.

The present disclosure proposes three main features, which are better than conventional schemes, to wit:

Firstly, the present disclosure may generate a 3D map using deep learning (DL) methods by detecting objects and calculating the movement distance to update the position of a device, by:
Utilizing camera to scan objects at surrounding environment and sensor to provide information of user's movement;
Applying Convolutional Neural Network (CNN) to estimate depth map of objects on images that has been filtered;
Generating the 3D map using images and sensor data that has been filtered and labeled;
Calculating distance between objects that are present in the context of the taken images;
Applying Fast Fourier Transformation (FFT) to calculate movement from one point to another by processing accelerometer data; and
Updating position of devices by combining both the generated 3D map and the calculated distance.

Secondly, the present disclosure may trace the location of paired devices by detecting objects and retrieve images to recognize certain place or location, by:
Identifying objects inside the images and produce a list of objects captured on the images;
Applying CNN to extract features from the images, and use Region Proposal Network (RPN) to detect potential objects as proposals in the feature map;
Recognizing the proposal using classifier to determine the class of the proposed object based on its feature maps; and
Retrieving images to recognize similar objects and calculate the similarity level to create a flag.

Thirdly, the present disclosure may provide virtual directions in the form of AR, by:
Checking the flags created to determine if the system has found any traces of other devices; and
Combining maps generated and searching for the shortest path to connect the agent by calculating the relative distance between devices.

The present disclosure can provide an intelligent object tracking system capable of providing an augmented virtual assistance by detecting an object in a spatial environment to reproduce a 3D map and track the location.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWING

To understand the disclosure and to see how the present disclosure can be implemented in practice, some embodiments will be described with reference to the accompanying drawings, wherein:

FIG. 1 illustrates the concept showing the overall process of an intelligent object tracing system utilizing 3D map reconstruction for virtual assistance according to various embodiments;

FIG. 2 shows a general overview of utilizing image filtering, dynamic environment detection, location tracing, and virtual direction augmentation methods according to various embodiments;

FIG. 3 shows a diagram flow of the overall system according to various embodiments;

FIG. 4 shows a sample use case scenario of intelligent object tracing in parking lot according to various embodiments;

FIG. 5 shows a sample simulation of data collection process in parking lot according to various embodiments;

FIG. 6 shows a sample simulation of location tracing in parking lot according to various embodiments;

FIG. 7 shows a sample simulation of augmented reality virtual guidance in parking lot according to various embodiments;

FIG. 8 shows a sample use case scenario of intelligent object tracing to locate another user using smartphone according to various embodiments;

FIG. 9 shows a sample simulation of augmented reality virtual guidance in outdoor environment using smartphone according to various embodiments;

FIG. 10 shows a sample use case scenario of intelligent object tracing to locate another user using smart glasses according to various embodiments;

FIG. 11 shows a sample simulation of augmented reality virtual guidance shown on smart glasses according to various embodiments;

FIG. 12 shows an Image Filtering diagram according to various embodiments;

FIG. 13 shows a data scoring diagram according to various embodiments;

FIG. 14 shows a data filtering diagram according to various embodiments;

FIG. 15 shows a dynamic environment detection diagram according to various embodiments;

FIG. 16 shows an automatic 3d map generator diagram according to various embodiments;

FIG. 17 shows a depth estimation diagram according to various embodiments;

FIG. 18 shows a 3d map generation diagram according to various embodiments;

FIG. 19 shows a displacement calculation diagram according to various embodiments;

FIG. 20 shows a location tracing diagram according to various embodiments;

FIG. 21 shows an object detection diagram according to various embodiments;

FIG. 22 shows a place recognition diagram according to various embodiments;

FIG. 23 shows an image retrieval first part diagram according to various embodiments;

FIG. 24 shows an image retrieval second part diagram according to various embodiments;

FIG. 25 shows a place recommendation diagram according to various embodiments;

FIG. 26 shows a virtual direction augmentation diagram according to various embodiments; and

FIG. 27 shows a simulation of map combining process according to various embodiments.

### DETAILED DESCRIPTION

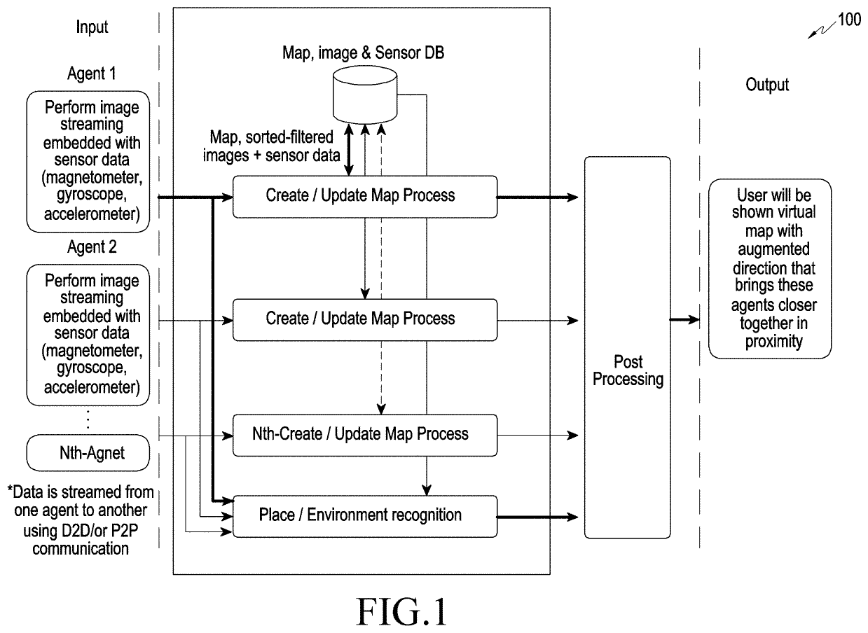

FIGS. 1 through 27, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Preferred embodiments and their advantages are best understood by reference to FIGS. 1 through 27 accordingly, it is to be understood that the embodiments of the disclosure herein described are merely illustrative of the application of the principles of the disclosure. Reference herein to details of the illustrated embodiments is not intended to limit the scope of the claims, which themselves recite those features regarded as essential to the disclosure.

FIG. 1 illustrates the concept showing the overall process of an intelligent object tracing system utilizing 3D map reconstruction for virtual assistance according to various embodiments.

Referring now to FIG. 1, the intelligent object tracing system 100 utilizing 3D map reconstruction for virtual assistance as shown in FIG. 1 may be hereinafter referred as an Intelligent Object Tracing System.

As described in FIG. 1, the present disclosure may provide an intelligent object tracing system 100 by creating or updating a 3D map using data obtained from camera and sensor, and perform recognition of certain places or environments. Generally, a GPS connection is needed for object tracing and map reconstruction to get a precise and accurate position. However, the present disclosure may utilize images and sensor data from magnetometers, gyroscopes, and accelerometers, and may not require a GPS connection. Any device used to collect the data is referred to as an agent. This disclosure may initiate interaction by connecting the agents to enable data streaming from one agent to another using device-to-device (D2D) or point-to-point (P2P) communication. The system of FIG. 1 may perform post-processing based on a map creation/update process and a location/environment recognition, and present (or output) a virtual map in an augmented direction that brings the agent closer to the user.

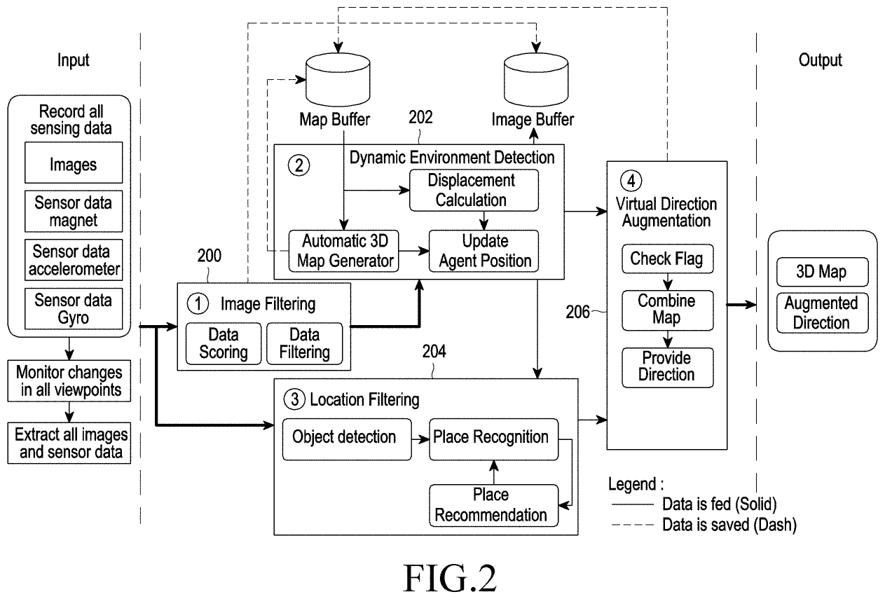

FIG. 2 shows a general overview of utilizing image filtering, dynamic environment detection, location tracing, and virtual direction augmentation methods according to various embodiments.

Referring now to FIG. 2, there are three stages of processes in this disclosure, which are of acquiring data, processing, and augmenting available images and sensor data captured by the intelligent object tracing system. In FIG. 2, the system 100 may provide the functions inclusive of (i) image filtering 200 (data scoring/data filtering), (ii) dynamic environment detection 202 (displacement calculation/automatic 3D map generator/agent location update), (iii) location tracking 204 (object detection/place recognition/place recommendation), and (iv) virtual direction augmentation 206 (flag check/map combination/direction provision).

At the first stage, the disclosure may initiate data acquisition by calculating changes in the point of view of the camera and starts to collect data when the value is high. In the second stage, there is the intelligent object tracing system that consists of four main processors, image filtering, dynamic environment detection, location tracing, and virtual direction augmentation , wherein the main focus of these processors is to score and filter collected data, generate 3D map, trace objects in certain locations, and provide directions. On the last stage, the system actuates the results from the intelligent system, by displaying (outputting) the 3D map and the augmented virtual directions on the interface. These four processors can be collectively referred to as a processor.

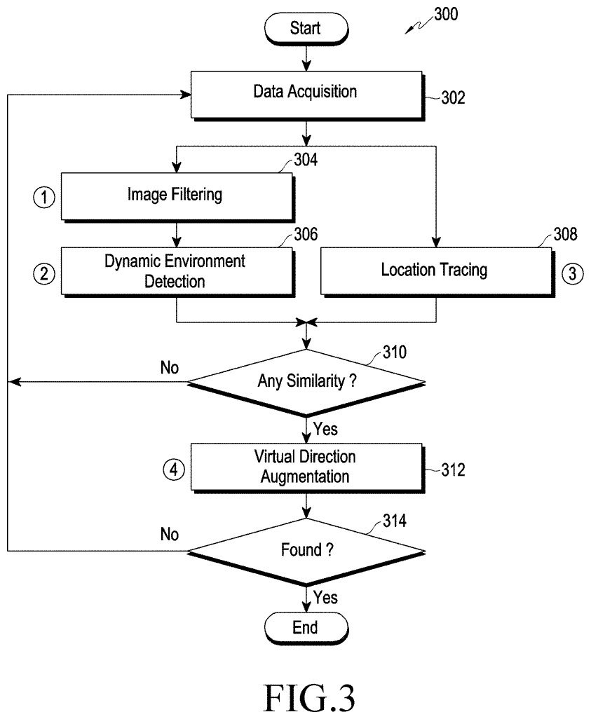

FIG. 3 shows a diagram flow of the overall system diagram 300 according to various embodiments.

Referring now to FIG. 3, it describes a flow of the overall system diagram 300 of the intelligent object tracing system. In step 302, data acquisition process initiates when changes in an agent's point of view are caused by a multidirectional shift, in a direction that is horizontal, vertical, forward, or reverse. In step 304, the collected data is transferred and processed simultaneously in the image filtering 200 and the location tracing processor 204. The image filtering processor 200 provisions a score to each data based on the level of information on the data, and filters the data based on the weighting score to maximize the process and optimize data saving.

In step 306, the filtered data may be used by the dynamic environment detection processor 202 to create a 3D map and map the position of the agent. In step 308, while in location tracing , the system analyzes the acquired data by comparing it with data acquired by other agents, and, in step 310 searches for context similarity of objects captured in the data streams and maps generated from other agents.

In step 312, when the intelligent system finds a matching object, the system may initiate virtual direction augmentation processor (iv) to combine the maps generated by the agents and provide directions to the agents. In step 314, the intelligent system may repeat the processes described until the location of other agents are found.

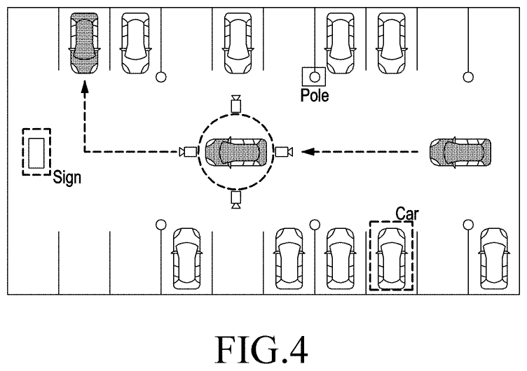

Referring now to FIG. 4 through FIG. 7, a user scenario of using Intelligent Object Tracing System to locate the position of automobile in an indoor parking lot is described.

People tend to have a short-span of memory, and some of them may find it difficult to remember the location of their automobiles in a parking lot. The present disclosure can overcome the situation and automatically provide guidance to users who need to locate their parking location.

Each of multiple agents involved in this scenario may include a dash-cam installed on the automobile, surveillance cameras in the parking lot, and a user's smartphone.

FIG. 4 shows a sample use case scenario of intelligent object tracing in parking lot according to various embodiments. As shown in FIG. 4, the intelligent object tracing system may capture objects found in the parking lot, including road markings and pillar signs, as data input for the intelligent system. Assuming the system in the parking lot will provide a pre-defined 3D map model by collecting data of surrounding environment from on-premise surveillance cameras, the user entering the parking lot may activate the system and initiate pairing over the network with the system in the parking lot.

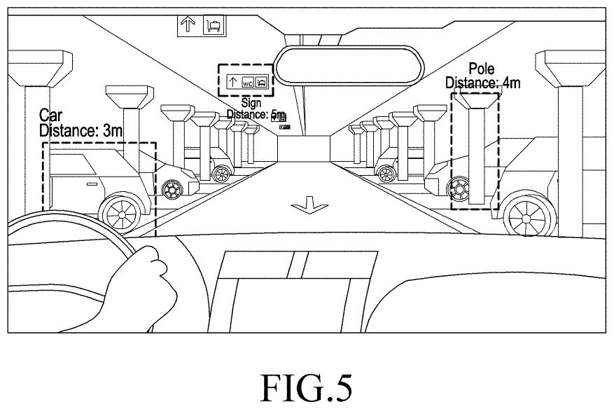

FIG. 5 shows a sample simulation of data collection process in parking lot according to various embodiments. As shown in FIG. 5, the system on the dash-cam may start scanning the markings and signs, and continuously measure the distance of the car, using the dash-cam's point of view, relative to other objects. The pre-defined 3D map model may be used to update the position of the automobile, and the system may pinpoint the position on the map.

When user is locating the automobile position in the parking lot using smartphone, user is required to pair the smartphone with the system in the parking lot to be able to retrieve the pre-defined 3D map embedded with the location of the automobile.

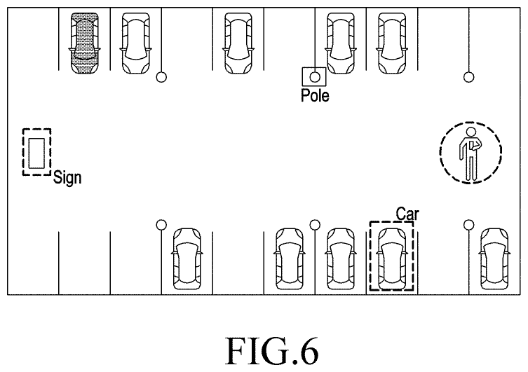

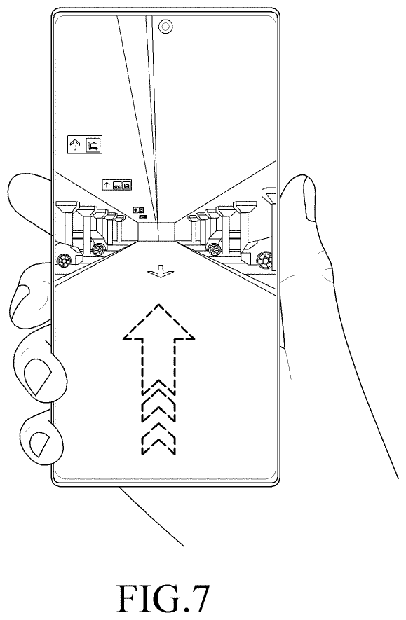

FIG. 6 shows a sample simulation of location tracing in parking lot according to various embodiments, and FIG. 7 shows a sample simulation of augmented reality virtual guidance in parking lot according to various embodiments. As shown in FIG. 6, the user may collect data of surrounding environment to retrieve the relative position to known objects on the map. When the intelligent object tracing system found any similar objects defined in the 3D map model, the intelligent object tracing system can display virtual direction in the form of AR map to guide the user to the location of the automobile, as shown in FIG. 7.

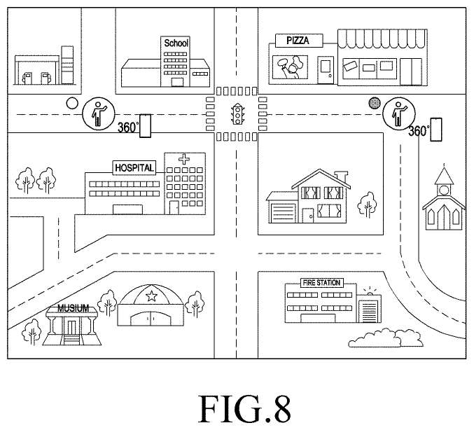

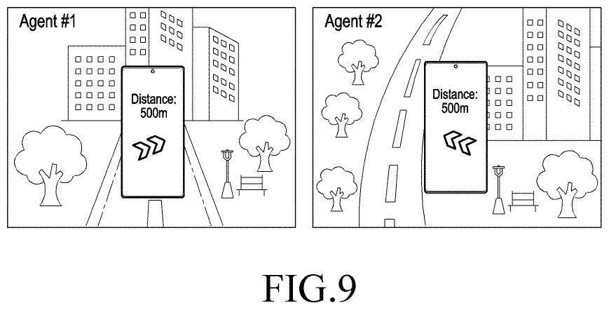

FIG. 8 shows a sample use case scenario of intelligent object tracing to locate another user using smartphone according to various embodiments, and FIG. 9 shows a sample simulation of augmented reality virtual guidance in outdoor environment using smartphone according to various embodiments.

Referring now to FIG. 8 & FIG. 9, described is the user scenario of smartphone-to-smartphone location tracing in outdoor environment in downtown area. Since there are many high-rise buildings in a downtown area, people may find it difficult to get GPS signal because of the interference. This disclosure works as an alternative to offer a solution to locate a person by using a camera system and advanced image processing built in the smartphone.

This intelligent system works when two or more users have exchanged contact information and pair their smartphones over the network. The system may indicate if users are connected, and is the ready to be used. Users on both ends may start to scan and capture objects of their surroundings using their respective cameras.

As shown in FIG. 8, the system may start to construct a 3D map and embed the position while users are scanning the environment. The system may determine the position of users when one of them finds similar object or place scanned by other users previously. When the system identifies a similar object or place, the virtual guidance may be shown on the smartphone's interface in the form of an AR map, as shown in FIG. 9. The system may continuously display the virtual directions to get the users closer in proximity.

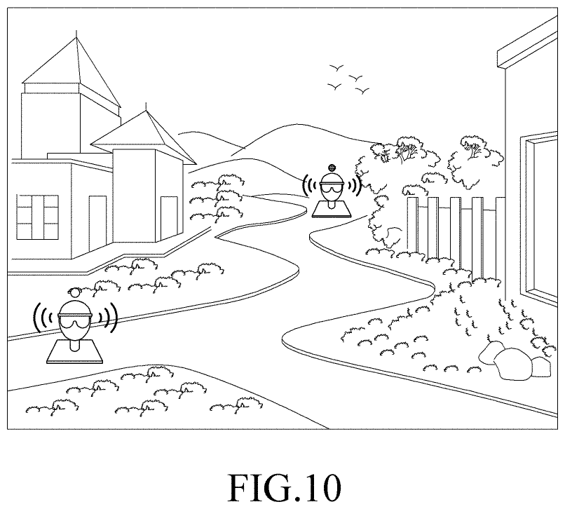

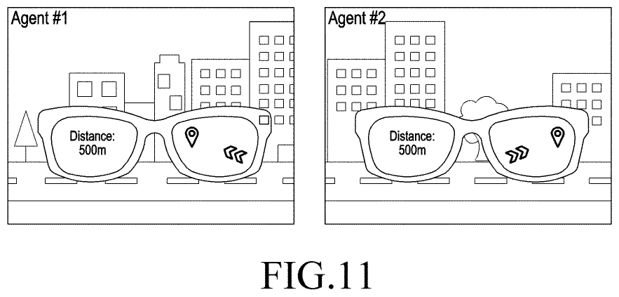

FIG. 10 shows a sample use case scenario of intelligent object tracing to locate another user using smart glasses according to various embodiments, and FIG. 11 shows a sample simulation of augmented reality virtual guidance shown on smart glasses according to various embodiments.

Referring now to FIG. 10 & FIG. 11, described is the user scenario of smart glasses-to-smart glasses location tracing in outdoor environment in downtown area. This user scenario may be similar to the previous scenario, showing that the system can be implemented to various devices with minimum requirement of camera system and sensors.

After pairing the smart glasses as agents, the users on both ends can start to scan and capture objects of their surroundings using the smart glasses. As shown in FIG. 10, the system may construct a 3D map model and embed user's location on the map. The system may perform this action continuously, and simultaneously search the position of other users when one of the users found similar object or place scanned by other users. When similar objects or places have been identified, the users may be shown virtual guidance on their smart glasses. Then, the system may keep on showing virtual direction to get users closer in proximity, as shown in FIG. 11.

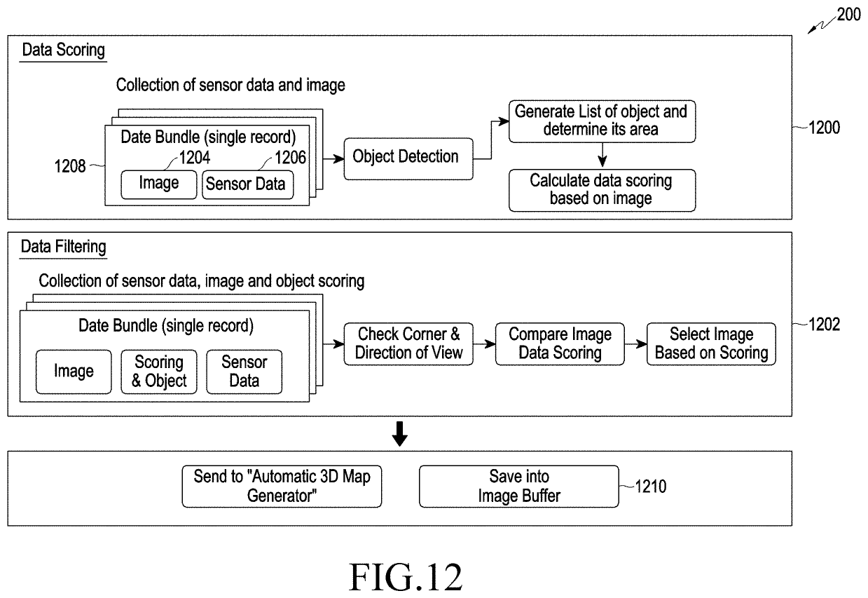

Referring now to FIG. 12 through FIG. 14, described is the image filtering processor 200, which consists of two subprocessors: data scoring 1200 and data filtering 1202. The image filtering may be the first step in this disclosure, to filter incoming data and optimize storage capacity usage on devices.

FIG. 12 shows an image filtering diagram according to various embodiments.

As shown in FIG. 12, the collection of images 1204 and sensor data 1206, herein after referred as data bundle 1208, may be processed by the data scoring subprocessor 1200 and data filtering subprocessors 1202. The data bundle 1208 may be saved into an image buffer 1210 in local database (DB) and transferred to the next processor, dynamic environment detection 202.

The image filtering processor 200 may select and keep data containing the richest information, and decompress the data bundle. The data scoring subprocessor 1200 may scan the data bundle to generate list of detected objects, and calculate the score of each data based on the level of information provided.

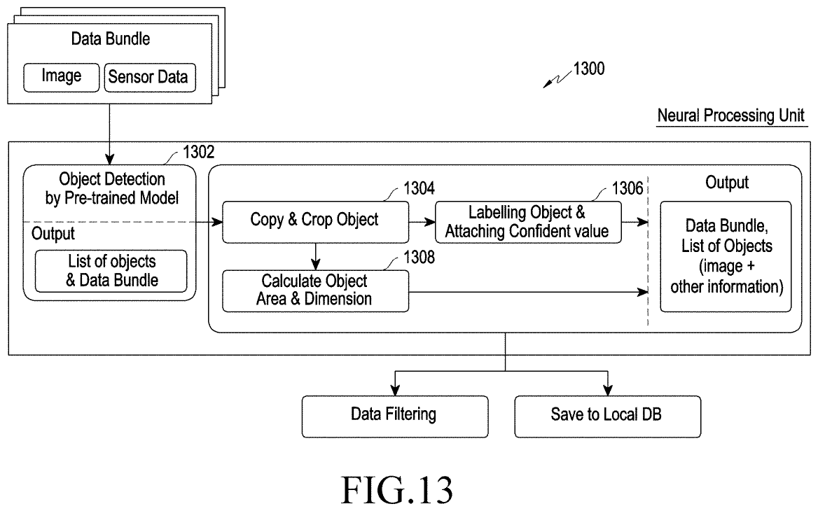

FIG. 13 shows a data scoring diagram 1300 according to various embodiments. As shown in FIG. 13, the data may be processed using object detection 1302 to evaluate and crop 1304 objects captured, and calculate the level of information it provides. Every recognized object may be then labeled 1306 and attached with a confidence value. This subprocessor may also calculate 1308 the area of the objects to determine the intactness of objects. Assuming any object form that is more intact may contain more information, thus the higher the confidence value. The present disclosure may utilize NPU to process the object detection and data scoring, and uses pre-trained model to achieve reasonable processing time.

When the scores are determined, the data bundle may be stored in the local/client database (DB) and the system may then initiate the data filtering subprocessor.

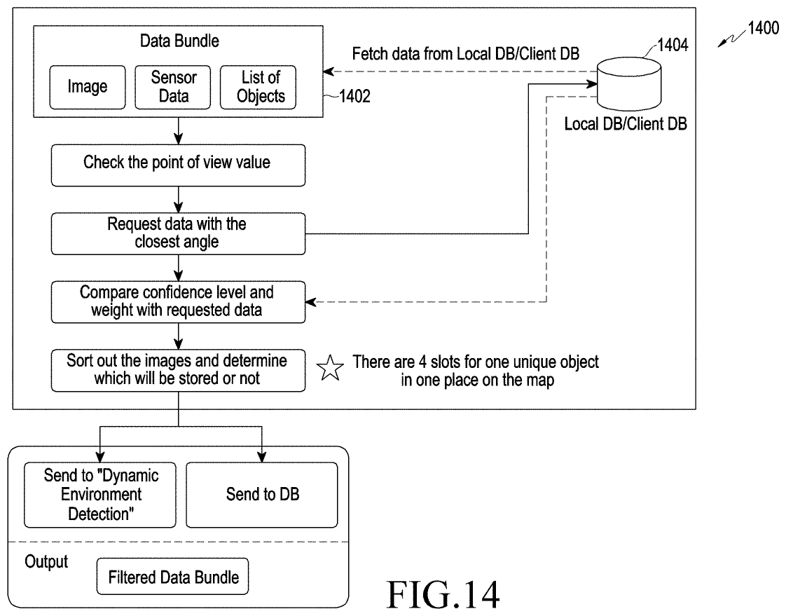

FIG. 14 shows a data filtering diagram 1400 according to various embodiments. As shown in FIG. 14, the data bundle 1402 may be fetched from the database 1404 and clustered based on certain angle value. The object may be selected and saved based on its confidence value and area of object. The system may generate a filtered data bundle for generating 3D map, saved into a joint DB. The system may allocate four slots of image reference for each object at a certain point on the map to avoid losing too much information in this subprocessor.

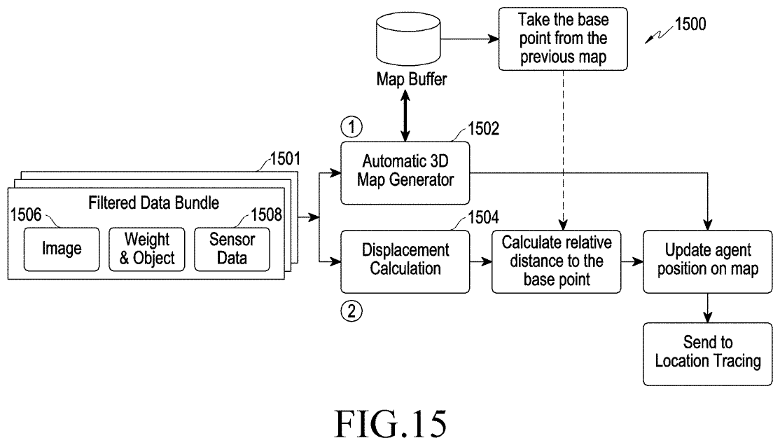

Referring then to FIG. 15 through FIG. 19, described is the dynamic environment detection processor 202, which consists of two subprocessors: automatic 3D map generator 1502 and displacement calculation 1504. The dynamic environment detection processor may use four input parameters, which are images 1506 and sensor data 1508 from a magnetometer, a gyroscope, and an accelerometer. Images may be used as the main input to construct the map, complemented with magnetometer data to save the context of a location point within the map. Sensor data from accelerometer and gyroscope may be used to calculate agent's movement. The four parameters are the minimum input requirements for this disclosure. The objective of this processor is to create a map, calculate position of agent, and update the position of agent on the map.

FIG. 15 shows a dynamic environment detection diagram 1500 according to various embodiments. As shown in FIG. 15, the filtered data bundle 1501 may be processed simultaneously on automatic 3D map generator 1502 to create a 3D map using images in the filtered data bundle 1501, and displacement calculation 1504 to calculate the movement of an agent within the map space.

The automatic 3D map generator 1502 may add information at certain points when the system found recognized objects based on the image, object label, and magnetic sensor value collected by other agents. The displacement calculation may use the sensor value from accelerometer and gyroscope to calculate the relative position of agent's last location. The 3D map generated on this processor may be stored as a map buffer in the DB, while the agent's relative position can be converted into absolute position on the map.

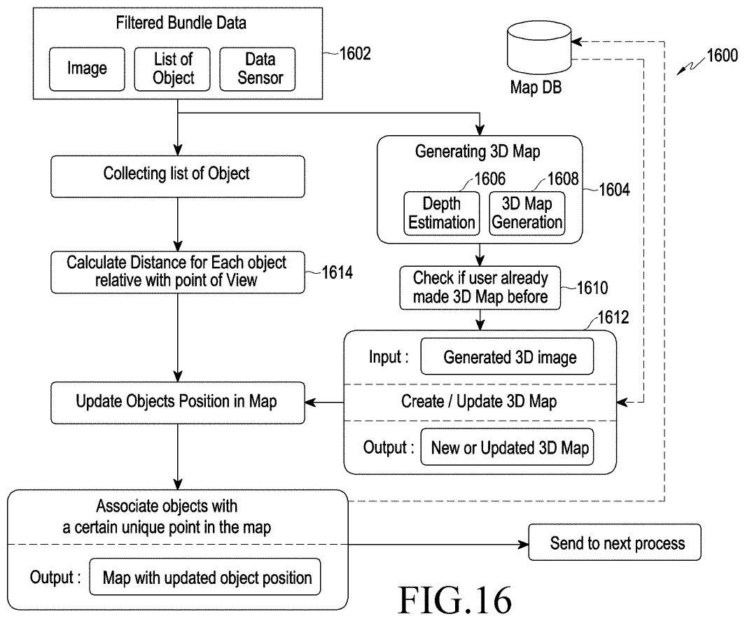

FIG. 16 shows an automatic 3d map generator diagram 1600 according to various embodiments. As shown in FIG. 16, the filtered data bundle 1602 may be processed to generate the 3D map based on the updated location context contained in the data in step 1604. The process of generating the 3D map may involve DL algorithm using neural network to estimate the depth map in step 1606 and generate the 3D map in step 1608. After the 3D map is generated, the system may check 1610 the DB to see if the agent already has a map stored in the DB. In step 1612 If the agent already has a map in the DB, then the map may be updated, and if the agent does not have a map in the DB, then the system may store the generated map. The system may also calculate the distance between objects that are present in the context of the images taken in step 1614. This is needed to ensure that the map is provided with additional information other than agent's position.

The neural network may estimate the depth map by analyzing ego-motion from the whole image and compute transformation vector per objects in 3D space. Therefore, it needs to segment the objects in the image prior to generating depth map.

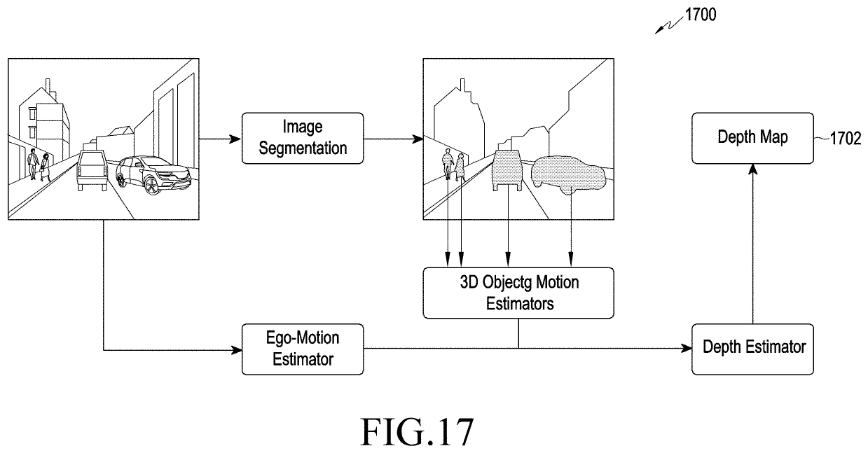

FIG. 17 shows a depth estimation diagram 1700 according to various embodiments. As shown in FIG. 17, the model may use the 2D optical flow to estimate the depth map 1702. The depth map 1702 later can be used to help construct 3D map by providing depth information to every reconstructed frame in the 3D map generation. The depth estimation may help the 3D map generation to put the estimated 3D points of a scene or an object in the correct location relative to the agent location. The generated 3D map may act as visual cue for directions to agents when the system recognizes the same objects captured by both the agents.

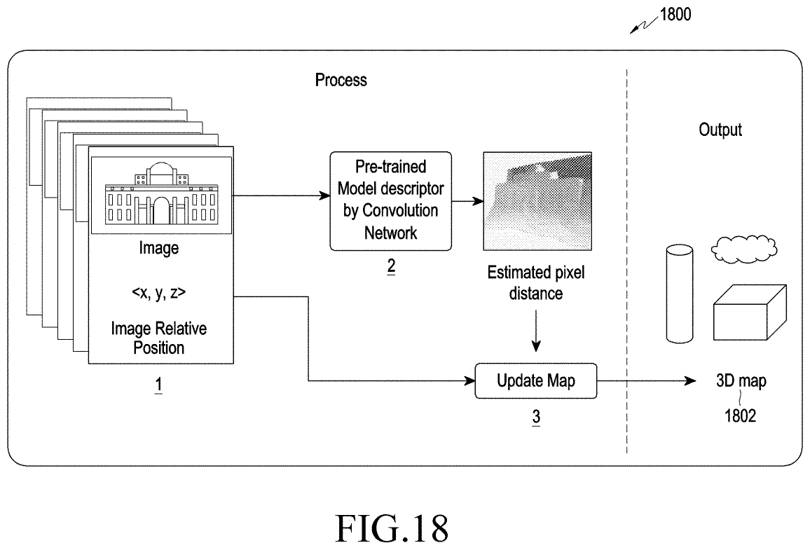

FIG. 18 shows a 3d map generation diagram 1800 according to various embodiments. The present disclosure may use CNN descriptor to create contour and 3D objects inside the 3D map 1802 by inserting several images and its relative position, as shown in FIG. 18. The DL algorithm may then estimate the distance of every objects on the processed images.

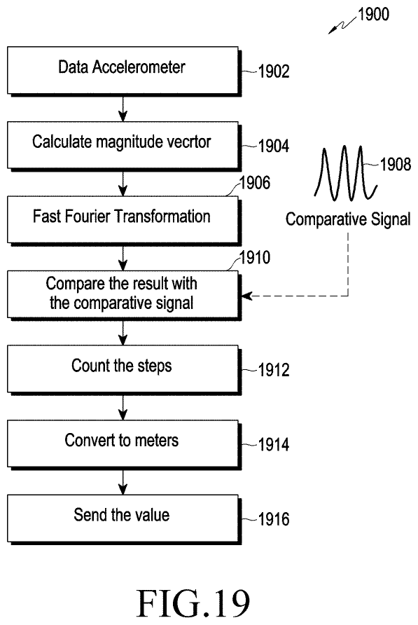

FIG. 19 shows a displacement calculation diagram 1900 according to various embodiments. As shown in FIG. 19, the system may calculate the movement of agent starting from the base point using sensor data from the data accelerometer 1902 in step 1904. The sensor data is converted into signal using Fast Fourier Transformation 1906, so it can be compared with the comparative signal 1908 in step 1910 to count the total steps from agent's position in step 1912. The signal may be converted into a distance in meter units to be used on the map in step 1914. As the last process, the system sends the value for the signal converted into a distance in meter units in step 1916.

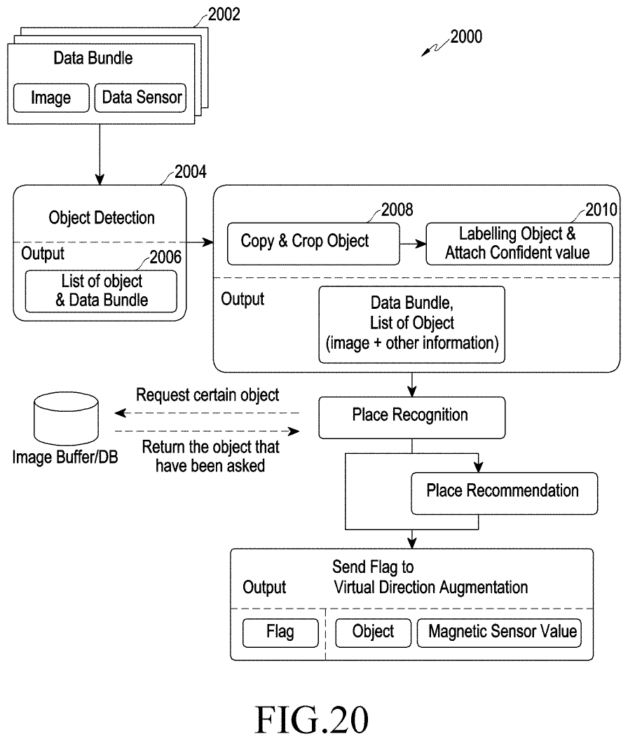

Referring now to FIG. 20 through FIG. 25, described is the location tracing processor that can determine the action for the last processor in this disclosure. As described in FIG. 3, the location tracing processor may run along with the previously mentioned processors to execute the functionality of this disclosure. The location tracing processor may be comprised of three subprocessors: object detection, place recognition, and place recommendation.

FIG. 20 shows a location tracing diagram 2000 according to various embodiments. As shown in FIG. 20, data bundles 2002 received are processed in the object detection subprocessor 2004 to identify and list objects 2006 in the data bundles, which resulted to a more refined data bundle. The system may copy and crop the images based on the available objects in step 2008. The remainder of the copied images may be listed in the object list. Images of objects may be then labeled and attached with its confidence value in step 2010.

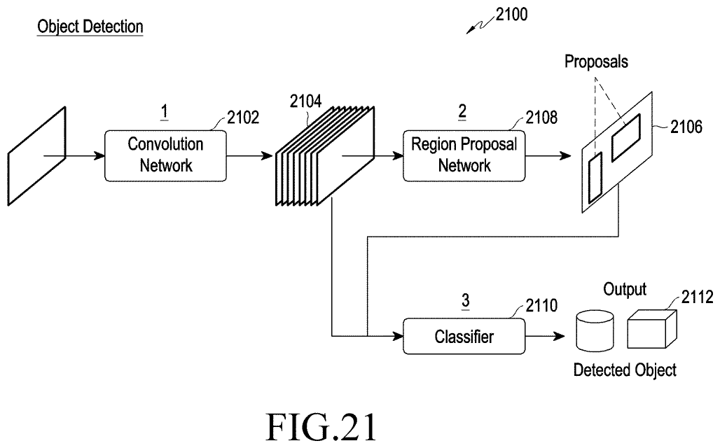

FIG. 21 shows an object detection diagram 2100 according to various embodiments. As shown in FIG. 21, CNN 2102 is used to extract features 2104 in the object detection processor. The potential objects, herein after referred as proposals 2106, may be detected in the feature map using RPN 2108. The proposals may be recognized using classifier 2110 to determine the class of the proposed object based on its feature maps. This processor may be used to detect objects 2112 in the data bundle, and store it in the Image Buffer.

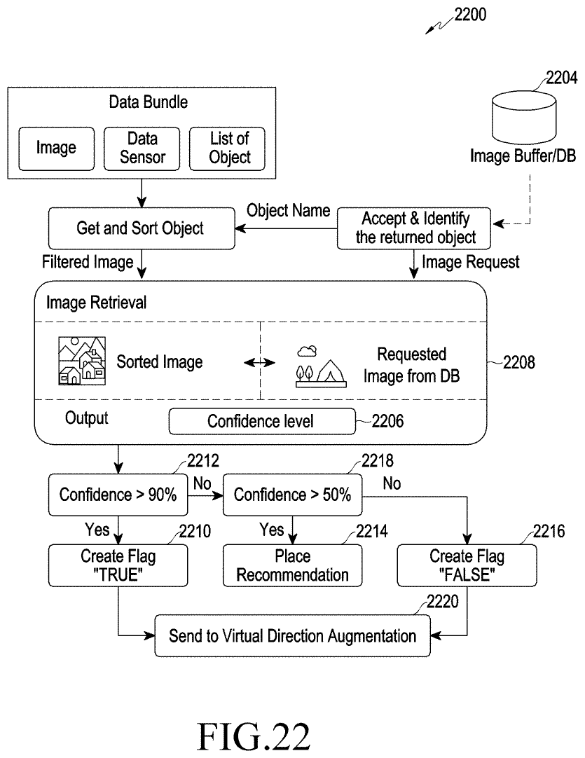

FIG. 22 shows a place recognition diagram 2200 according to various embodiments. As shown in FIG. 22, the system may run the place recognition processor 2202 by recognizing familiar objects in the image buffer 2204. The image references may be filtered based on the related object when there is a match. Confidence level 2206 resulted from image retrieval process 2208 may be used to decide the creation of flag to determine the end result of this disclosure.

The place recognition processor may create the flag with two possible values: TRUE or FALSE. In step 2210, a TRUE flag may be created when the similarity of objects based on its confidence value, herein after referred as similarity level, is more than 90 percent in step 2212. If the similarity level is ranging from 50 percent to 90 percent, then the system may run place recommendation processor 2214. In step 2216, a FALSE flag may be created when the similarity level is below 50% in step 2218, which means that the system is finding difficulties to detect similar objects and may be unable to show virtual assistance on the agents' interface in the virtual direction augmentation. In step 2220, the TRUE flag or FALSE flag are sent to the virtual direction augmentation.

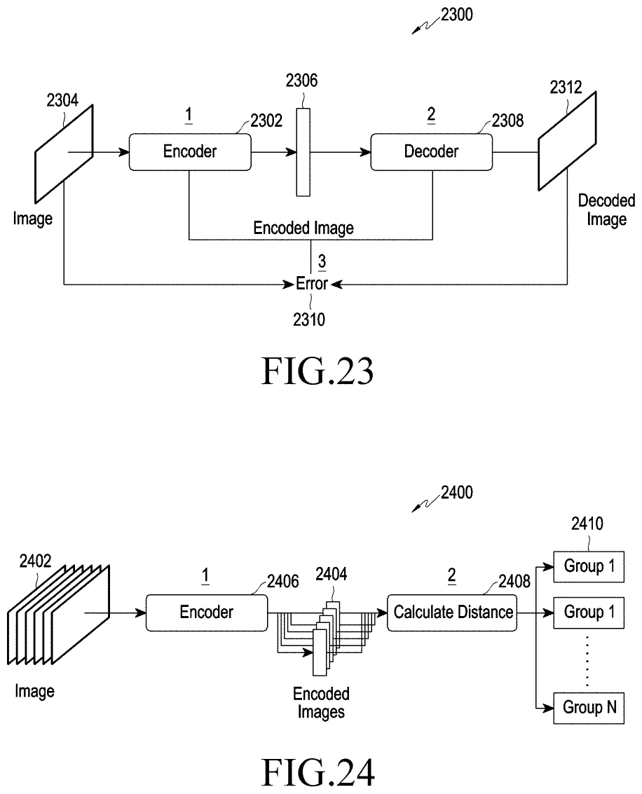

FIG. 23 shows an image retrieval first part diagram 2300 according to various embodiments. The image retrieval process may also involve training of its DL model, as shown in FIG. 23. The image retrieval process 2208 may use an encoder 2302 that is trained to cluster the images. Firstly, the encoder 2302 may first encode an image 2304 to a one-dimension (1D) vector 2306. Secondly, the decoder 2308 may try to restore the image from the 1D vector 2306. The difference (error) 2308 between the input image 2304 and decoded image 2312 becomes the feedback for the encoder and decoder neural network. As the training converges, the encoded image vector expresses certain properties and characteristic of the input such as color, texture, object shape, etc. to differentiate one image to another. In other words, similar image tends to have similar encoded vector.

FIG. 24 shows an image retrieval second part diagram 2400 according to various embodiments. As shown in FIG. 24, the image retrieval process may group the same images from the image buffer by encoding a batch images 2402 into vectors 2404 using encoder 2406. Every vector 2404 expresses characteristics of the respective image. Therefore, by comparing each vector 2404 and calculating its distance in step 2408, the vector that has distance below certain value may be grouped together in a group 2410. This means if the vector, which represents images, is in the same group, there is a high probability that the image captured is of the same object but from a different angle. If the same object is found, the system may send a notification.

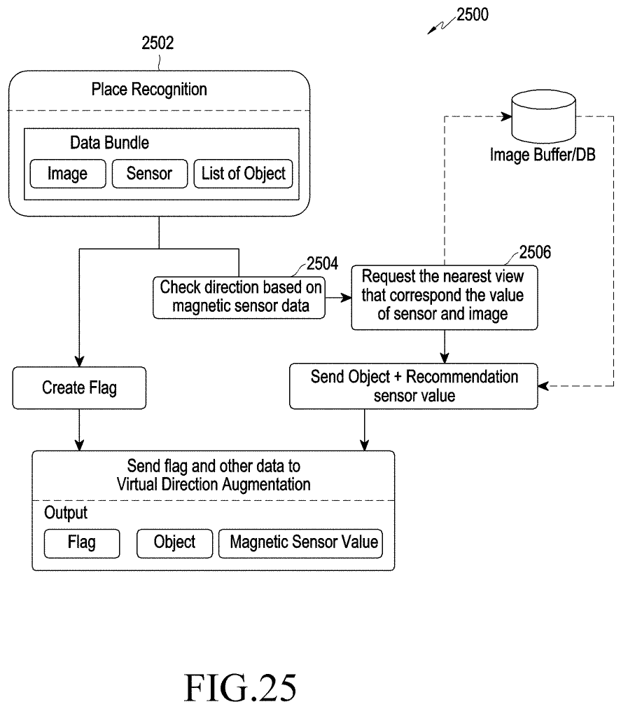

FIG. 25 shows a place recommendation diagram 2500 according to various embodiments. Referring now to FIG. 25, it describes the process in the place recommendation processor 2502 when the image retrieval algorithm is unsure whether a place has been explored or not, reflected by the similarity between 50 percent and 90 percent. This subprocessor may give a recommendation of object and direction to make the estimation of place recognition. Reference to a pair of objects listed from previous subprocessors and directions to the closest sensor value from object that has been recognized may be given by this subprocessor. In step 2504, the system may check the direction based on magnetic sensor value, and request the nearest view or place that can correspond to the value of sensor and image stored in the image buffer or local DB in step 2506. The output of this subprocessor is the value of magnetic sensor and object that can be used to decide which object to be selected by the agent in the next iteration and flag that can determine the end result of this disclosure.

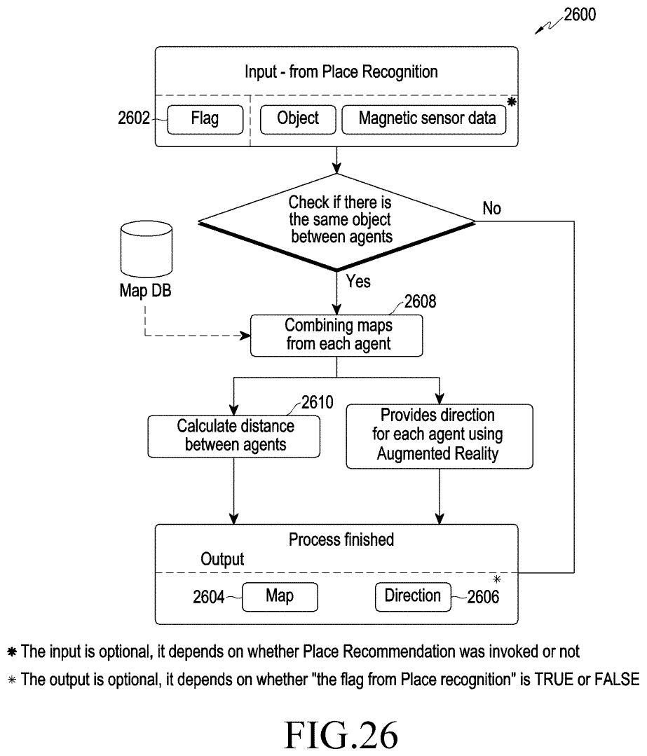

Referring now to FIGS. 26 & 27, describes the last processor of the present disclosure, that is, the virtual direction augmentation processor. FIG. 26 shows a virtual direction augmentation diagram according to various embodiments.

The virtual direction augmentation processor 206 may evaluate the results achieved from dynamic environment detection and location tracing. The virtual direction augmentation 206 may use the flag 2602 resulted from the place recognition as the main parameter, or the optional parameter resulted from place recommendation. The output of virtual direction augmentation processor may be in the form of a map 2604 and directions 2606. It is notable that the desired output is also optional depending on the flag input value. The virtual direction augmentation starts with checking the flag input. This flag input may provide an overview if the system has found any clues of other agents' location. When the flag value is FALSE, the system may end the process and the acquired data may be re-processed without the provision of virtual directions to other objects until the agent manages to scan and detect objects that are already traced by other agents. When the flag value is TRUE, the system may run a series of processes, as shown in FIG. 26.

The first task that the system performs is to combine the maps by fetching the maps generated from involving agents in step 2608. The maps may be combined so that every agent can find out the location of other agents and every single detail of objects that are contained in the map captured by involving agents. Once the maps are combined, the system may search for the fastest path on the map to connect the agents by calculating the relative distance between agents to give an estimation of their location from other agents in step 2610. The relative distance between agents can be calculated after the shortest path between agents is found on map. The process to find the shortest path can be applied using several path finding algorithms, such as Bellman Ford's algorithm, Dijkstra's algorithm, or Floyd-Warshall's algorithm. Once the shortest path is determined, the system may estimate the distance by converting the path to a commonly used unit.

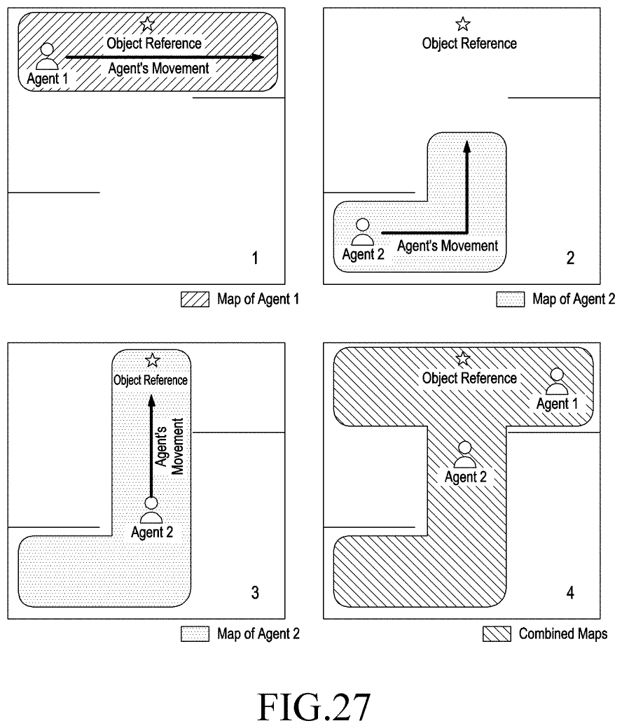

FIG. 27 shows a simulation of map combining process according to various embodiments. The process of combining the agents' generated maps and calculating the relative distance between agents may use an object reference as a base for the map combination, as shown in FIG. 27. The system may also calculate the relative distance between agents to find out the shortest path to reach the location of other agents. The system may then initiate the virtual assistance in the form of AR directions. After the system combines/merges the maps from paired agents and calculates the shortest path, AR may be then used to illustrate the path and directions that the users can follow. The path may be shown in the form of lines and arrows on the surface detected on the viewfinder.

This system revolves around the overall user experience in using virtual assistance. The ego-motion estimator implemented in the automatic 3D map generator processor can improve the precision of an AR object to the real object. The system can help determine an agent location and movement besides using the accelerometer, magnetometer and gyroscope sensors. Furthermore, the system could also use the objects on the 3D map to provide a higher level of virtual assistance. With the help of the 3D objects that were formed earlier, the system can create an image of objects that are blocked and provide more a precise path. For example, the system may show the silhouette of a car or tree that is covered by building walls. A more precise direction can be obtained by incorporating these 3D objects as consideration in the provisioning of path directions. The system can provide an alternate path whenever there is a static object blocking the user's path. The whole series of processes may be finished when the user manages to meet with other users.

Although the present disclosure has been described with various embodiments, various changes and modifications may be suggested to one skilled in the art. It is intended that the present disclosure encompass such changes and modifications as fall within the scope of the appended claims.

What is claimed is:

1. An object tracing system using data obtained from an electronic device and a plurality of sensors, the object tracing system comprising an image filtering module, a dynamic environment detection module, a location tracing module, and a virtual direction augmentation module, wherein:
the image filtering module decompresses and stores necessary data according to the level of information to filter and score the obtained data;
the dynamic environment detection module detects the same object identified by each agent and provides an augmented virtual direction for each agent, and the location tracing module sends a notification on movement of the same object when the paired electronic device recognizes the same object; and
the virtual direction augmentation module, being installed in the paired electronic device, is automatically activated to start generating the virtual direction and transmit an expected virtual direction inclusive of a remaining distance, and if a similarity level between objects calculated by the location tracing module is higher than a threshold value, the virtual direction is displayed on an interface of the device.

2. The object tracing system according to claim 1, wherein the electronic device is at least of a smartphone, a wearable device, or a camera, and each of the plurality of sensors is any one of a magnetometer, an accelerometer, and a gyroscope.

3. The object tracing system according to claim 1, wherein the image filtering module, being included in the object tracing system, retrieves all the objects identified by the object tracing system and assigns a score to all the objects and the surrounding environment based on the level of provided information; and the filtered data is used as a reference when compared with data streamed from another electronic device.

4. The object tracing system according to claim 1, wherein the dynamic environment detection module, being included in the object tracing system, automatically generates and updates a 3D map based on a Convolutional Neural Network (CNN) and the filtered data, and adds information of an object recognized on the 3D map; and then performs a fast Fourier transform to convert the sensor data obtained from the plurality of sensors in a meter unit to calculate a moving distance from a starting point.

5. The object tracing system according to claim 4, wherein the object tracing system identifies all scanned objects extracted from the filtered data and segments the objects using an ego-motion analysis in the image frame, estimates a depth map to generate a 3D map, and arranges an expected 3D point of a scene or an object in a correct position for the position of the agent;
when a previously generated 3D map is found, the system updates the distance between the objects within the scanned surrounding environment, and provides an estimated distance between the scanned object and the agent displayed on an interface of the object tracing system;
the system estimates the depth map using the ego-motion analysis from the entire image, and arranges the estimated 3D point of the scene or the object in the correct position on the basis of the agent position to calculate an object-specific transformation vector in a 3D space using a 2D optical flow; and
when the object tracing system recognizes the same object captured by a plurality of agents, the system generates the 3D map to use as a reference for indicating a virtual direction to the agent.

6. The object tracing system according to claim 1, wherein the object tracking system applies the location tracing module to continuously update the position of the agent by detecting objects and identifying the objects taken by other agents;
the system utilizes CNN and Region Proposal Network (RPN) to detect all the objects that are captured in the images;
the system utilizes the image retrieval algorithm to determine the level of similarity when the scanned objects matches the image reference from database of other agent; and
the system prompts the user to scan the objects from different angle or position, or find other objects that are similar within the surrounding environment when the similarity level calculated by the system is lower that a threshold value.

7. The object tracing system according to claim 6, wherein the object tracing system identifies all the scanned objects and create a list of objects to be labeled and attached with similarity level that will be used in comparison to a list of objects from other agents;
the system retrieves images contributed by the paired agents to search for similarities to create a flag that will determine the end result;
the system creates TRUE flag when the object tracing system found the similarity level is more than 90%, and if the object tracing system finds the images matched but the confidence level is ranging from 50% to 90%, then the object tracing system prompts the user to scan objects from different position or angle, or move from the current position; and
the object tracing system creates FALSE flag when the similarity level is below 50%.

8. The object tracing system according to claim 1, wherein the virtual direction augmentation module, being included in the object tracing system:
utilizes outputs from the dynamic environment detection module to provide visualization of detected objects and determine the position of agents on the generated map;
utilizes outputs from the location tracing module to determine the provision of direction to reach the location of other agent by comparing the similarity level of scanned objects with the reference images on database; and
performs a combination of the map when the similarity level of scanned objects calculated on the location tracing module by combining all maps generated by the paired agents is higher that a threshold value, and displays AR directions on the interface using the ego-motion estimator to illustrate the recommended path for the user to follow.

9. The object tracing system according to claim 8, wherein;
the object tracing system checks the output of the location tracing module to determine if the object tracing system will display the virtual direction on the interface;
when the output is FALSE flag, the object tracing system ends the data processing;
when the output is TRUE flag, the object tracing system combines all the generated 3D maps by agents to determine the location of all the agents and provide detailed information of the scanned objects on the map;
the system uses image references from all the agents as a base of map combination, and calculates the estimated distance between the agents to determine the shortest path on the map to connect the agents using path finding algorithm;
the system augments the direction on the interface using arrows based on the calculated distance, also augments static objects that are blocked by other objects, and provides an alternative path by referring to the list of scanned objects by other agents.

10. A method of operating an object tracing system using data obtained from an electronic device and a plurality of sensors, the object tracing system comprising an image filtering module, a dynamic environment detection module, a location tracing module, and a virtual direction augmentation module, the method comprising:
decompressing and storing necessary data, by the image filtering module, according to the level of information to filter and score the obtained data;
detecting, by the dynamic environment detection module, the same object identified by each agent and providing an augmented virtual direction for each agent;
transmitting, by the location tracing module, a notification on the movement of the same object when the paired electronic device recognizes the same object; and
automatically activating the virtual direction augmentation module installed in the paired electronic device to start generating the virtual direction and transmit an expected virtual direction inclusive of the remaining distance, and if the similarity level between objects calculated by the location tracing module is higher than a threshold value, displaying the virtual direction on an interface of the device.
